(19) United States
(12) Patent Application Publication
(10) Pub. No.: US 2008/0086982 A1
(43) Pub. Date: Apr. 17, 2008

(54) INSULATING PANEL AND PROCESS OF MAKING SAME

(76) Inventors: Martin PARENTEAU, Drummondville (CA); Stephane MORASSE, Kingsey Falls (CA); Aileen C. Sarmiento, Mississauga (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/857,683

(22) Filed: Sep. 19, 2007

Related U.S. Application Data
(60) Provisional application No. 60/845,512, filed on Sep. 19, 2006.

(51) Int. Cl. E04C 2/36; B32B 27/00

(52) U.S. Cl. 52/794.1; 52/309.4; 52/745.19; 52/793.1

(57) ABSTRACT

The insulating panel has a honeycomb structure core made of repulpable material and two skins sandwiching the core. Insulating particles can be used in the cells. One or both skins can have a layer of thermally insulating material, such as expanded polystyrene, for example. Nonetheless, by incorporating some repulpable components, the insulating panel can be made more interesting to recycle than an all-expanded-polystyrene insulating panel. The process of making can include driving a honeycomb web made of repulpable material and having a first and a second opposite faces, and adhering a first skin web to the first face. Optionally, the cells can be filled by insulating particle. A second skin web is applied to the second face.

### CROSS-REFERENCE TO RELATED APPLICATIONS

This application claims priority of U.S. Provisional Patent Application No. 60/845,512, filed Sep. 19, 2006, the contents of which is hereby incorporated.

### FIELD

The specification relates to a thermally insulating panel with a honeycomb-structure core sandwiched between two skins.

### BACKGROUND

Expanded polystyrene is often used in thermally insulated panels due to its rigidity, and relatively low density. However, expanded polystyrene is made from a non-renewable resource and is not easily recyclable because of its light weight and low scrap value. Furthermore, expanded polystyrene is typically very long to decompose in nature (biodegrade). For these reasons, the use of expanded polystyrene in thermally insulating panels of applications such as food packaging has been banned in several cities. There is a need that is felt for insulating panels which are more environmentally-friendly than expanded polystyrene panels in applications such as food packaging and construction materials.

### SUMMARY

A sandwich-structure insulating panel incorporating a honeycomb structure made of a repulpable material can be more interesting to recycle than an all-expanded-polymer panel. It can at least reduce the amount of expanded polymer used in the panel. Any resulting tradeoff in costs or thermal resistance can be acceptable for some applications.

Sandwich-structure panels are known in the field of composite materials, and are fabricated by attaching two relatively thin but stiff skins to a lightweight but thick honeycomb core. The honeycomb core has material arranged in a manner to define a regular array of cells. The cell shape can be hexagonal, square, triangular, or quasi-circular, for instance, depending of the application. The higher thickness of the core provides the sandwich structure panel with high bending stiffness with overall low density.

In accordance with one aspect, there is provided an insulating panel comprising: a core having a honeycomb structure of repulpable material, the honeycomb structure having an array of cells; and two skins sandwiching the core, at least one of the two skins having a layer of thermally insulating material, each one of the two skins being at least one of substantially hand-removable from the core and made of a recyclable material.

In accordance with another aspect, there is provided a process of making an insulating panel, the process comprising: driving a core web of a honeycomb structure and repulpable material having a first and a second opposite faces, and a longitudinally-extending array of transversally-oriented open cells; and adhering a first skin web having a layer of insulating material to the first face of the core web.

In accordance with another aspect, there is provided an insulating panel comprising: a core portion having a honeycomb structure made of a wood fiber based material and defining two spaced-apart substantially planar surfaces and providing air space therebetween; and an insulating foam material layer bonded to a respective face of the core portion.

In accordance with another aspect, there is provided an insulating panel comprising: a core having a honeycomb structure of repulpable material, the honeycomb structure having an array of cells; two skins sandwiching the core, each one of the two skins being at least one of substantially hand-removable from the core and made of a recyclable material; and a plurality of insulating particles substantially filling the cells.

In accordance with another aspect, there is provided a process of making an insulating material, the process comprising in sequence: adhering a first skin to a first face of a honeycomb structure having an array of cells; filling the cells with particles of insulating material through a second face of the honeycomb structure; and adhering a second skin to the second face of the honeycomb structure.

### DESCRIPTION OF THE FIGURES

FIG. 1 is a perspective view of an example of an insulating panel;

FIG. 2 is a cross-sectional view taken along lines 2-2 of FIG. 1;

FIG. 3 is a perspective view of another example of an insulating panel;

FIG. 4 is a perspective view of another example of an insulating panel;

FIG. 5 is a cross-sectional view taken along lines 5-5 of FIG. 4;

FIG. 6 is a cross-section view of another example of an insulating panel;

FIG. 7 is a schematic view of a process of making an insulating panel;

FIG. 8 is a perspective view of an example of a box made with a plurality of insulating panels;

FIGS. 9, 10, 11, and 12 are cross-sectional views showing specific examples of insulating panels.

### DETAILED DESCRIPTION

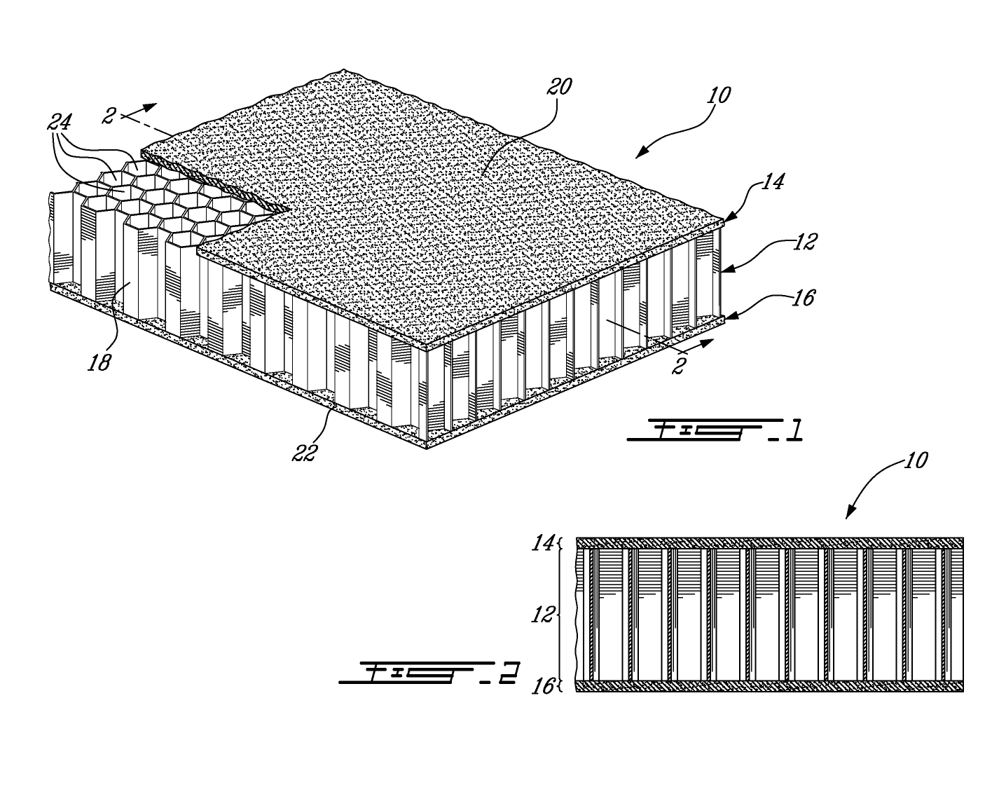

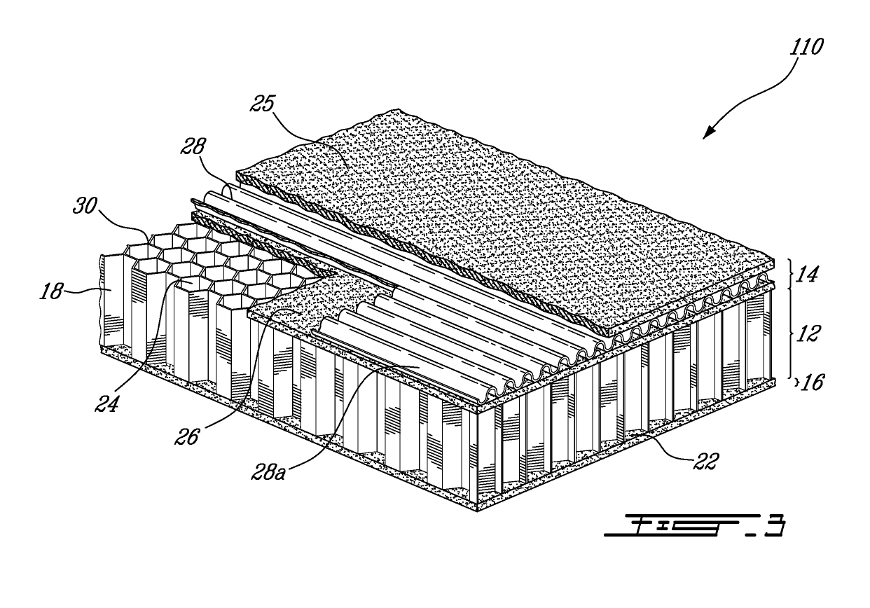

FIGS. 1 and 2 show an example of an insulating panel 10. The insulating panel 10 has a sandwich-type structure with a core 12 sandwiched between a first skin 14 and a second skin 16. The core 12 has a hexagonal cell honeycomb structure 18. Each skin 14, 16 is a respective layer 20, 22 of an expanded polymer directly adhered to the honeycomb structure 18.

The insulating panel 10 uses much less expanded polymer than an insulating panel which does not have a honeycomb core. Yet, the insulating panel 10 offers a relatively high amount of thermal insulation due to the combination of the two layers 20, 22 of expanded polymer and the presence of air trapped in the cells 24 of the honeycomb structure, between the two skins 14, 16. For illustrative purposes, the expanded polymer can be polystyrene, polypropylene, polyethylene, or polyethylene teraphtalate, for example.

The sandwich structure provides for a relatively high overall flexion and impact resistance, while offering a relatively low overall density and weight.

Furthermore, selecting a repulpable material, such as recycled paperboard for instance, as the material for the honeycomb structure 18 can render the insulating panel 10 quite interesting to recycle, as compared to a full panel of expanded polystyrene for example. The recycling can be done in a recycling facility where the insulated panel 10 is shredded, and subsequently separated into its different constituents: such as expanded polymer and repulpable material, for instance.

Even if the insulating panel 10 is not recycled, the use of a wood-based honeycomb structure 18 will typically make the insulating panel 10 more biodegradable than a panel having the same thickness, but being made entirely of an expanded polymer. Furthermore, the degradability of expanded polymers can be enhanced by adding pro-degradant additives during their manufacturing process. Therefore, in applications where there is a focus on the degradability aspect of the insulating panel, an oxo-degradable expanded polymer can be used, such as polystyrene having a TDPA® additive for example.

The insulating panel 10 can thus be an interesting substitute to expanded polymer boards. The insulating panel 10 can be used as a material for making insulating packaging such as insulated boxes, for instance.

In construction material applications, a sheet of an insulating construction-grade textile, such as spunbonded olefin (a brand of which is manufactured by DuPont under the trademark Tyvek®), or a felt-type material for example, can be used instead of expanded polymer as a layer of insulating material. Other types of insulating materials can also be used.

When used in packaging boxes which are designed to contain ice, or when used as external building insulation, it can be advantageous that an exposed face of the insulating panel have a surface that is substantially impermeable to liquid water.

In embodiments where the insulating material used in one or both skins is not recyclable, the layer of that insulating material can be selected to be removable by hand, so that once the useful life of the insulating panel ends, the non-recyclable layer of insulating material can be easily removed and discarded, and the remainder of the panel be recycled. Alternately, the layer of insulating material can be designed to be mechanically removed.

Many alternate embodiments to the one depicted in FIGS. 1 and 2 are possible. For instance, in some applications, one of the layers of expanded polymer can be replaced by a non-insulating material, such as a linerboard for example. Also, one or both of the skins can include more than one layer of insulating material, and/or can include one or more additional layer(s) of non-insulating material. In some instances, it can be advantageous to add a polymer film layer, such as for increasing the resistance of the insulating panel to liquid water, for instance.

One alternate embodiment is depicted in FIG. 3. In this example, the first skin 14 of the insulating panel 110 include two layers 25, 26 of expanded polymer sandwiching a corrugated medium 28, such as a fluted fiberboard sheet 28a. The lower layer 26 of expanded polymer is adhered to the upper face 30 of the honeycomb structure 18. It will be noted that the lower layer 26 of expanded polymer can be replaced by a linerboard in an other alternate embodiment, for example. The second skin 16 can have an expanded polymer layer 22 or a linerboard, for example.

In the previously described examples, one factor which can limit the amount of thermal insulation achieved is natural convection occuring in the cells 24 of the honeycomb structure when the insulating panel is in use.

The thermal insulation of a sandwich-structured panel can be increased by filling the cells with particles, to impede natural convection in the cells. The selected particles can have a low thermal conductivity, to impede heat transfer by conduction across the particles.

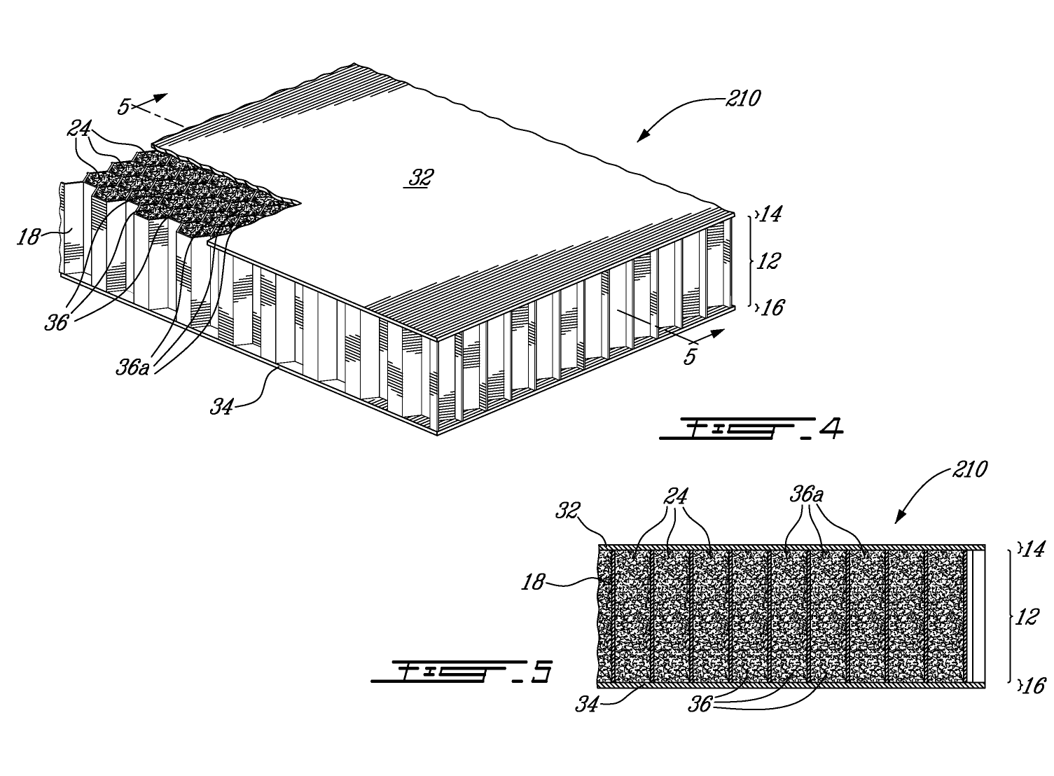

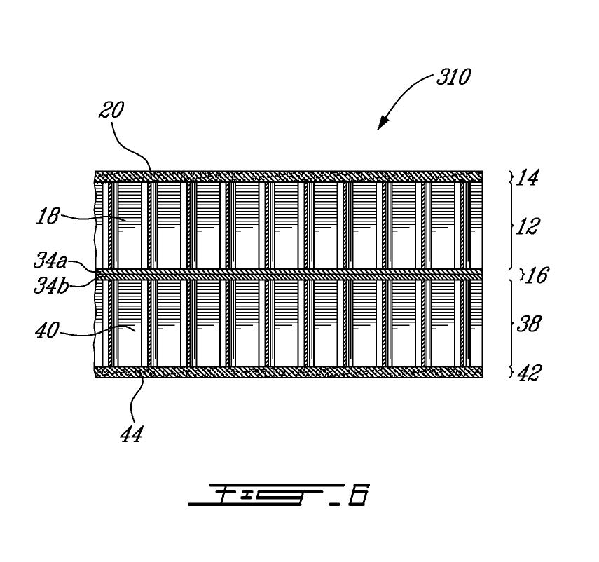

In the example shown in FIGS. 4 and 5, the insulating panel 210 has a core 12 with a honeycomb structure 18 made of a repulpable material, and has two skins 14, 16, each skin 14, 16 having a respective single linerboard layer 32, 34. The cells 24 of the honeycomb structure 18 are filled with insulating particles 36.

In this instance, paper shreds 36a can be used as the insulating particles 36, so as to offer an entirely repulpable insulating panel 210. Shreds of expanded polymer material, which can be obtained from expanded polymer sheet trims for example, or other insulating particles, can be used in alternate embodiments. Using insulating particles in a form, texture, and size which allows them to fall relatively easily into the cells can help assembling the panels. This falling-ability can vary depending on the cell diameter. Insulating particles can otherwise be blown into the cells or fed thereinto using any other suitable process, for example.

It will be understood that if more thermal insulation is desired, one or both of the linerboards 32, 34 can be replaced by a skin having a layer of insulating material.

Another way of encouraging high thermal resistance by impeding natural convection is to use two superposed honeycomb cores in an insulating panel instead of a single core. Typically, for a given panel thickness, using two superposed honeycomb cores instead of one will yield a greater amount of thermal insulation, due to the added restriction to natural convection.

In the example shown in FIG. 6, an insulating panel 310 having two cores 12, 38, each having a honeycomb structure 18, 40, is shown. The first core 12 is sandwiched between the first skin 14 and the second skin 16, and the second core 38 is sandwiched between the second skin 16 and a third skin 42. In this example, an expanded polymer sheet 20 is used in the first skin 14, two linerboards 34a, 34b are used in the second skin 16, and an expanded polymer sheet 44 is used in the third skin 42. Different skins 14, 16, 42 can be used with the two cores 12, 38. In many embodiments, the second skin 16 can include two layers: a first layer associated to the first core 12 and a second layer associated to the second core 38. Either one of these two layers, or both, can be an expanded polymer sheet or a linerboard, for example. This double-layer construction can result of the superposition of two insulating panels, or of the folding of a single insulating panel back onto itself. Some alternate embodiments can also have a second skin 16 with a single material layer, for example.

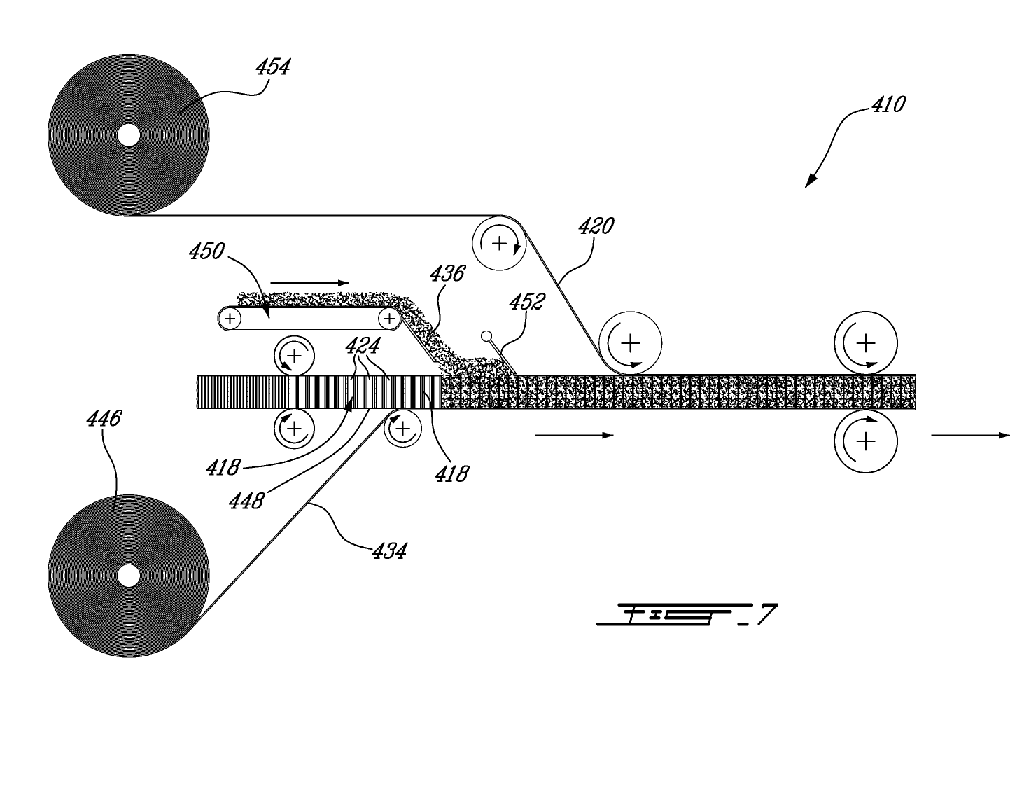

Turning now to FIG. 7, an example of a process 410 for producing an insulating panel on-line, as a continuous process, is shown. A web of honeycomb material 418 is provided by expanding the honeycomb material from a folded state. A first skin 434 is unrolled from a first roll 446 into a web, and adhered to a first face 448 of the expanded honeycomb web 418. In this example, an optional step of dropping insulating particles 436 in the cells 424 takes place. The insulating particles 436 can be carried by a conveyor 450, for example, and dropped into the upper, open end of the cells 424. A rake 452 or a similar device can be used to remove insulating particles 436 from the upper ends of the honeycomb structure 418. A second, upper skin 420, which can be provided as a web by unrolling from a second roll 454, is then applied to the upper face of the honeycomb structure 418, thereby closing the cells 424, and trapping therein the insulating particles 436. It will be noted here that in embodiments where the step of putting insulating particles in the cells is omitted, both skins can be applied simultaneously. Linerboards and sheets of expanded polymer having a relatively small thickness can both be unrolled from rolls.

In various embodiments, several adhesives can be used to adhere the skins to the core portion and/or to adhere the layers of the skins to one another. For example, water-based adhesives such as polyvinyl alcohol (PVOH), polyvinyl acetate (PVA), acrylic, stamp glue, silicate solutions, and dextrin, can be used. Hot melt adhesives such as polyolefin and ethylene vinyl acetate (EVA) can also be used. Polyurethane can also be used.

In some embodiments, it can be advantageous to use a repulpable adhesive. In other embodiments, it might be desirable to use an adhesive that remains on the faces of the honeycomb structure or an adhesive that bonds very rapidly. In some instances, a pressure-sensitive adhesive can be used. The pressure-sensitive adhesive can be activated by applying pressure on the two components being bonded together and including the adhesive therebetween. Alternately, a polymer layer can be applied between the two components and be activated, to bond the components together by heat or pressure, for example. Simultaneously, the polymer layer can enhance the barrier properties of the resulting insulating panel.

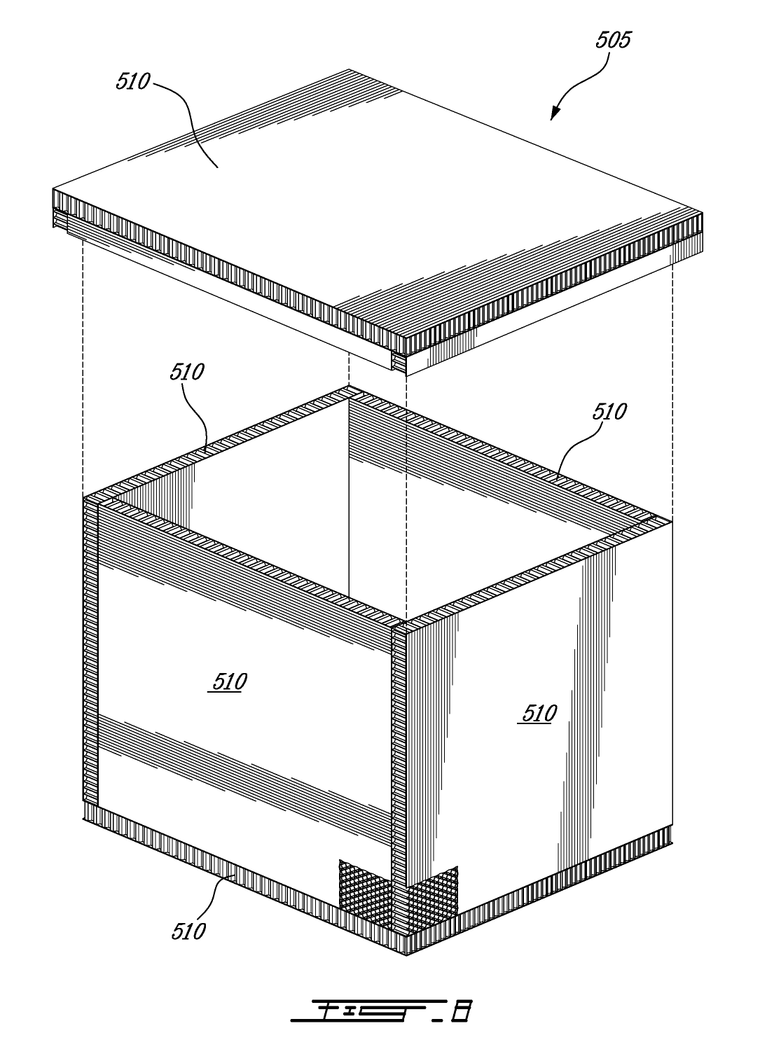

Turning to FIG. 8, a packaging box 505 made with a plurality of insulating panels 510 is shown. The packaging box can be used alone, or incased in a cardboard box, for example.

FIGS. 9, 10, and 11 each show a specific example of an insulating panel 610, 710, 810, each specially adapted for use in making a particular type of packaging box.

FIG. 9 shows a first specific example of an insulating panel 610. The core 612 includes a honeycomb structure 618 which defines two substantially planar surfaces 656, 658, or faces, which are spaced-apart from one another. A respective skin 614, 616 is adhered to each face 656, 658 of the honeycomb structure 618.

The first skin 614 is a linerboard 632, laminated directly onto the planar surface 656. The second skin 616 includes a linerboard 634, adhered directly onto the planar surface 658, a corrugated medium 660, adhered on the linerboard 634, another linerboard 662, adhered to the corrugated medium 660, a polyethylene layer 664, adhered to the linerboard 662, and a foam material layer 622 of expanded polymer laminated on the polyethylene layer 664.

The corrugated medium 660 is a B-flute. The cell diameter and the thickness of the honeycomb type material 618 is approximately ⅜″ and 4″ respectively. The repulpable honeycomb material has a 26 lbs/1000 ft² structural loading and a 60 psi compression strength and is assembled with a water-based adhesive. For indicative purposes, repulpable honeycomb materials having 18 to 69 lbs/1000 ft² are commonly available, and can alternately be used in various alternate embodiments. The linerboards 632, 634, 662 are #42 linerboards. The polyethylene layer 664 has a coat weight of 25 g/m². The expanded polymer 622 is an oxo-degradable polystyrene having a 1/16″ thickness and bonded to the polyethylene layer 664 with a dextrine adhesive. The resulting container, with the foam material layer 622 as the internal face, is particularly suitable for use in storing and shipping drugs surrounded by ice packs or a comparable cooling material.

The container can be made by assembling a plurality of insulating panels. The insulating panels can all be cut and assembled. Alternately, the container can include a folded insulating panel. The insulating panel can be made foldable by creating a V-groove in the insulating panel by means such as rolling a V-shaped wheel (cornerwheel) thereinto, for example. Using a polyethylene film 664 under the foam material layer 622 can help reduce the appearance of tearing in the foam material layer during the rolling of the V-shaped wheel, and/or help maintain water-resistance.

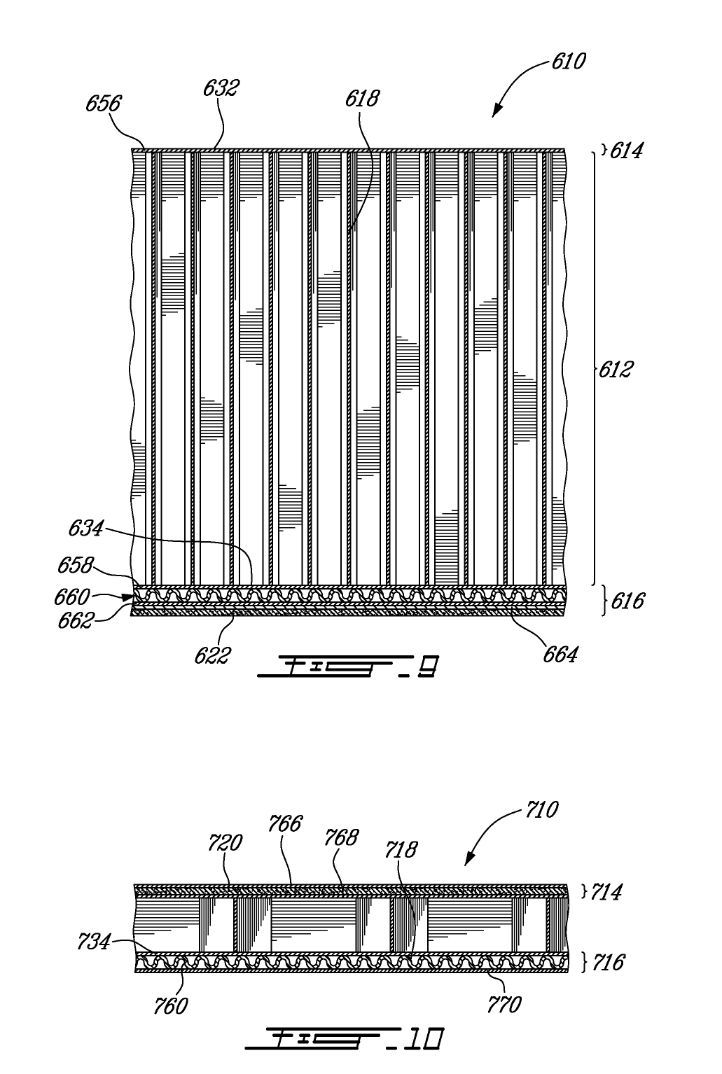

FIG. 10 shows another specific example of an insulating panel 710. A respective skin 714, 716 is adhered to each face of the honeycomb structure 718. The first skin 714 includes an expanded polymer 720 adhered between two linerboards 766, 768. One of the linerboards 768 is directly adhered to first face of the honeycomb structure 718. The second skin 716 includes a corrugated medium 760 adhered between a linerboard 734 and a chipboard 770. The linerboard 734 is adhered to the second face of the honeycomb structure 718.

The corrugated medium 760 is a micro-flute. The cell diameter and the thickness of the honeycomb type material 718 is approximately 1.5″ and ½″, respectively. The wood-fiber based repulpable honeycomb material is a #42 paperboard and is assembled with a PVA adhesive. The linerboards 766, 768, 734 are #42 linerboards. The expanded polymer 720 is an oxo-degradable polystyrene. The chipboard 770 is a 40 pts chipboard laminated with stamp adhesive. The resulting container can be used for storing and shipping meat or fish packed with ice, for example.

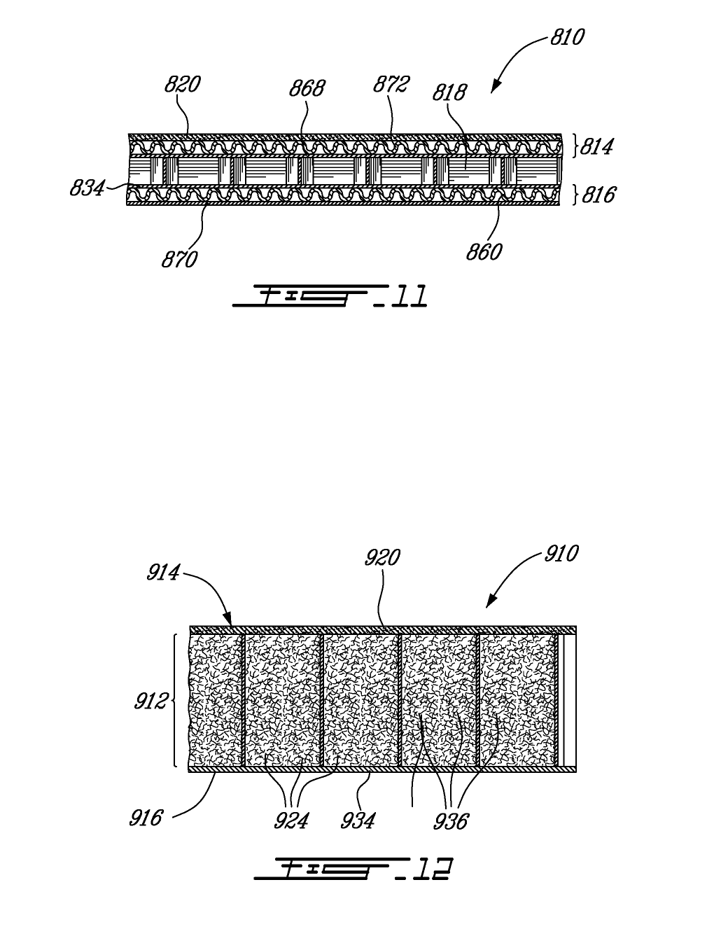

FIG. 11 shows another specific example of an insulating panel 810. A respective skin 814, 816 is adhered to each face of the honeycomb structure 818. The first skin 814 includes a corrugated medium 872 adhered between a linerboard 868 which is adhered to the first face of the honeycomb structure 818, and an expanded polymer layer 820. The second skin 816 includes a corrugated medium 860 adhered between a linerboard 834 which is adhered to she second face, and a chipboard 870.

The corrugated medium 872 and 860 can be a B-flute or a C-flute. The cell diameter and the thickness of the honeycomb type material 818 is approximately ⅝″ and ¼″ respectively. The honeycomb 818 is made of #42 paperboard and assembled with a polyurethane adhesive. The expanded polymer 820 is an oxo-degradable polystyrene having a ⅛″ thickness. The chipboard 870 is a 40 pts chipboard laminated with an EVA hot melt adhsive. The resulting container is particularly suitable for storing and shipping flowers, for example.

The insulating panel 910 shown in FIG. 12 has a core 912 with a 1″ thick honeycomb structure made of repulpable material and having ¾″ diameter cells. The first skin 914 has a 1/16″ layer 920 of oxodegradable polystyrene adhered to the honeycomb structure with a water-based adhesive. The second skin 916 has a 42 lbs/1000 ft² linerboard 934. The cells 924 of the honeycomb structure are filled with insulating particles 936 which primarily include shredded paper and shredded plastic particles—a material which is often used as insulation in rooves of houses and even in walls. Tests have demonstrated that this insulating panel 910 achieves an insulation capacity of 3.4R.

In comparison, 1″ thick panels made of molded expanded polystyrene can have about 3.7R for low-density, or 4R for high-density.

In various embodiments, the honeycomb structure can be made of wood fiber based materials or polymers, for instance. For wood fiber based materials, paperboard, cardboard, kraft paper, recycled paper, medium, chipboard, bleached or not, and the like can be used. It can be made entirely of recycled material. It can be impregnated with a resin to improve its resistance to water, grease or fire, its gas and vapor barrier properties, its non-slip properties, and the like. It can also be treated with a water-based coating or a resin coating.

The skins can include sheets of wood fiber based materials, sheets of expanded polymers including degradable polymers, polymers laminated on a wood fiber based material, polymers laminated between two layers of wood fiber based material, etc. The wood fiber based material layers and polymer layers can be structured (for example corrugated) or substantially flat.

The thickness of the insulating material layer can vary in accordance with specific needs.

A box shape of insulating panels can be used as a sleeve, outside a receptacle or box, or can be used inside a receptacle or box made of another material.

It will be understood that the examples described above and illustrated are exemplary only. The scope is indicated by the appended claims.

What is claimed is:

1. An insulating panel comprising: a core having a honeycomb structure of repulpable material, the honeycomb structure having an array of cells; and two skins sandwiching the core, at least one of the two skins having a layer of thermally insulating material, each one of the two skins being at least one of substantially hand-removable from the core and made of a recyclable material.

2. The insulating panel of claim 1 wherein the insulating material is an expanded polymer.

3. The insulating panel of claim 2 wherein the insulating material is exposed and directly adhered to the honeycomb structure.

4. The insulating panel of claim 1 wherein the insulating material is a construction-grade textile.

5. The insulating panel of claim 1 wherein the layer of insulating material is impermeable to liquid water.

6. The insulating panel of claim 1 wherein the cells are substantially filled with insulating particles.

7. The insulating panel of claim 1 further comprising a third skin, and a second core having a honeycomb structure of repulpable material sandwiched between a respective one of the two skins and the third skin.

8. A process of making an insulating panel, the process comprising:
driving a core web of a honeycomb structure and repulpable material having a first and a second opposite faces, and a longitudinally-extending array of transversally-oriented open cells; and
adhering a first skin web having a layer of insulating material to the first face of the core web.

9. The process of claim 8 further comprising adhering a second skin web to the second face of the web of honeycomb structure.

10. The process of claim 9 further comprising, between said adhering of the first skin web and said adhering of the second skin web, substantially filling the cells of the honeycomb structure by dropping insulating particles an open end of the cells on an exposed face of the core web.

11. The process of claim 9 wherein said adhering of the second skin web takes place before said adhering of the first skin web, and wherein said adhering of the first skin web closes the cells.

12. The process of claim 8 wherein the first skin web is a sheet of an expanded polymer.

13. The process of claim 8 wherein the first skin web is a construction-grade textile.

14. An insulating panel comprising: a core portion having a honeycomb structure made of a wood fiber based material and defining two spaced-apart substantially planar surfaces and providing air space therebetween; and an insulating foam material layer bonded to a respective face of the core portion.

15. The insulating panel of claim 14 wherein the insulating foam material is an expanded polymer.

16. The insulating panel of claim 14, comprising a substantially flat layer laminated between the core portion and the insulating foam material layer.

17. The insulating panel of claim 14, wherein the insulating foam material layer is bonded directly to one of the planar surfaces.

18. The insulating panel of claim 14, wherein the insulating foam material layer is degradable.

19. The insulating panel of claim 18, wherein the insulating foam material layer is polystyrene with a pro-degradant additive.

20. An insulating panel comprising: a core having a honeycomb structure of repulpable material, the honeycomb structure having an array of cells; two skins sandwiching the core, each one of the two skins being at least one of substantially hand-removable from the core and made of a recyclable material; and a plurality of insulating particles substantially filling the cells.

21. The insulating panel of claim 20 wherein the insulating particles are recyclable, and each one of the two skins are at least one of substantially hand-removable from the core and made of a recyclable material.

22. The insulating panel of claim 20 wherein the insulating particles are shreds of expanded polymer.

23. The insulating panel of claim 20 wherein at least one of the two skins has a layer of insulating material.

24. A process of making an insulating material, the process comprising in sequence:
adhering a first skin to a first face of a honeycomb structure having an array of cells;
filling the cells with particles of insulating material through a second face of the honeycomb structure; and
adhering a second skin to the second face of the honeycomb structure.

25. The process of claim 24 further comprising: expanding the honeycomb structure prior to said applying a first skin; wherein the steps of adhering a first skin, filling the cells, and adhering a second skin are done on-line as a continuous process.
